(19) United States
(12) Patent Application Publication
(10) Pub. No.: US 2025/0018435 A1
(43) Pub. Date: Jan. 16, 2025

(54) CLEANING DEVICE AND METHOD FOR CLEANING A LENS

(71) Applicant: Schneider GmbH & Co. KG, Fronhausen (Lahn) (DE)

(72) Inventors: Gunter Schneider, Marburg (DE); Jürgen Krall, Ober-Ramstadt (DE)

(21) Appl. No.: 18/711,456

(22) PCT Filed: Nov. 17, 2022
(86) PCT No.: PCT/EP2022/082353

§ 371 Date: May 17, 2024

(30) Foreign Application Priority Data
Nov. 19, 2021 (DE) 10 2021 005 750.3
Nov. 24, 2021 (DE) 10 2021 005 837.2

(51) Int. Cl. B08B 1/34; B08B 1/12; B08B 11/02

(52) U.S. Cl. CPC B08B 1/34; B08B 1/12; B08B 11/02

(57) ABSTRACT

A cleaning device and a method is for cleaning a lens. The lens is supplied to a respective cleaning station by a handling device and is held in a rotating manner by a rotatable holder.

### CROSS-REFERENCE TO RELATED APPLICATIONS

This application is the U.S. National Stage of PCT/EP2022/082353 filed Nov. 17, 2022, which claims priority to German Patent Application Nos. DE 10 2021 005 750.3 filed Nov. 19, 2021 and DE 10 2021 005 837.2 filed Nov. 24, 2021, the content of all of which are incorporated herein by reference in their entirety.

### FIELD OF THE INVENTION

The present invention relates to a cleaning device for cleaning at least one lens in and to a method of cleaning a lens.

In particular ophthalmic lenses, particularly preferably eyeglass lenses or lenses for eyeglasses, are to be understood by the term “lenses”.

In particular a cleaning by a mechanical treatment using a cleaning member such as a brush; a mechanical and/or chemical cleaning by the effect of a liquid, for example by spraying, rinsing, or dipping; and/or a cleaning by the action of an air flow or gas flow, for example by a fan, and/or for drying is to be understood by the term “cleaning” in the sense of the present invention.

### BACKGROUND OF THE INVENTION

A cleaning of the lenses is in particular required for a subsequent coating or surface treatment or surface enhancement of the lenses. The lenses in particular have to be cleaned and/or have to have a high degree of cleanliness for a coating or a surface treatment so that the coating adheres to the lens surface or so that no particles are trapped between the lens surface and the coating.

DE 10 2017 007 752 A1 discloses a device and a method for cleaning a lens, wherein the lens or the carrier with the lens can be selectively fed to a plurality or to all of the cleaning stations by means of a common handling device. The common handling device furthermore has a gripping device to grip the lens or the carrier with the lens and to hold it for cleaning in the respective cleaning station. Brushes are provided as the cleaning members for the mechanical and/or chemical cleaning. The lenses to be cleaned are in particular held in a non-rotatable manner during the cleaning process, but are rather travelable in a linear or translatory manner, in particular in an oscillating manner, transversely to the axis of rotation of the brushes.

### SUMMARY OF THE INVENTION

It is the underlying object of the present invention to provide an improved cleaning device and a further developed method, preferably wherein a thorough or particularly uniform cleaning and/or in particular a homogenization at residual structures and/or a variable use of the cleaning machine is/are made possible and/or supported with an in particular unchanging quality of the cleaning of the lens and/or a particularly simple or compact construction is made possible and/or supported.

The above object is achieved by a cleaning device as disclosed herein. Advantageous further developments are also disclosed.

The cleaning device in accordance with the proposal has at least one cleaning station for cleaning a lens and at least one handling device for feeding the lens to the cleaning stations or to the respective cleaning station.

A first aspect of the present invention comprises the handling device having at least one holder, in particular a rotatable holder, to hold the lens in a rotating manner, in particular during a cleaning process in the respective cleaning station.

The supply and/or positioning of the lens or of the holder with the lens in the respective cleaning station preferably takes place vertically or from above, in particular by lowering or dipping the holder or the holder with the lens into the respective cleaning station.

Further preferably, at least one cleaning station has a brush, in particular a rotatable brush, as the cleaning member.

The rotation of the lens or of the holder with the lens is conducive to a simplified or compact structure since only one rotation takes place about the axis of rotation of the holder per cleaning station and no linear or translatory movement takes place along a horizontal linear axis of the cleaning station or cleaning device.

This additionally makes possible an optimized and particularly thorough cleaning since the cleaning time of the lenses can be reduced or adapted or varied individually or in a lens specific manner by varying the speed of the drive of the holder and the lens surface to be cleaned is or can be acquired or cleaned particularly uniformly by the cleaning members or the cleaning agent, in particular by the brushes or by their bristles, by the rotation of the lens.

The rotational movement of the holder or of the lens in particular permits a longer application time of the bristle or of the contact force by the bristles on the lens surface, which is likewise conducive to a particularly thorough or efficient cleaning.

In accordance with a particularly preferred aspect of the present invention that can also be implemented independently, the axis of rotation of the holder or of the lens extends transversely or at east substantially perpendicular to the axis of rotation of the brush.

The axes of rotation of the holder and of the brush are preferably not skewed with respect to one another. The axis of rotation of the holder and the axis of rotation of the brush are preferably disposed at least substantially in a plane or intersect one another. A particularly reliable supply of the lens or of the holder with the lens to the respective cleaning members and a particularly compact construction are hereby made possible.

A further advantage is the accompanying harmonization of the introduction of the force of the bristles onto the lens surface or the stochastic variation of the contact force of the bristles at or on the lens surface. This makes a particularly uniform cleaning possible. Defects that irritate the human eye and/or are unavoidable such as structural formations that can in particular arise due to the contact of the lens surface by the bristles during a cleaning procedure can furthermore be particularly uniformly or homogeneously distributed over the lens surface by the rotational movement and the substantially perpendicular arrangement of the axes of rotation of the holder and the brush with respect to one another. This permits a harmonization at residual structures and reduces the risk of recognition of residual structures on the lens or lens surface by the in particular very sensitive human eye.

In accordance with a further aspect of the present invention, at least one handling device is provided for the at least one cleaning station, preferably for a plurality of cleaning stations that are preferably arranged next to or behind one another in the horizontal direction. The handling device is in particular configured for the transfer of the lens in the horizontal direction.

A common handling device is particularly preferably provided for a plurality or for all of the cleaning stations. This is conducive to a particularly simple and compact structure. The in particular common handling device preferably has a separate holder for each of the cleaning stations, in particular for the selective or individual and/or lens specific feeding or positioning, and in particular the cleaning, of the lens.

An “individual” or “lens specific” cleaning in the sense of the present invention in particular means that the cleaning in the respective cleaning station can be optimized or adapted independently of the cleaning in a different cleaning station of the cleaning device in accordance with the proposal for the respective lens and/or independently of the cleaning of other lenses. This is in particular very easily possible, and in particular provided, by the cleaning device in accordance with the proposal and by the method in accordance with the proposal.

A handover device is preferably provided between the cleaning stations, in particular in the case of a respective one holder per cleaning station or also in the case of a plurality of handling stations, for the transfer of the lenses from one cleaning station to another. This permits a selective or individual transfer of the lenses to a cleaning station depending on the desired cleaning demands.

In this embodiment of the cleaning device in accordance with the proposal, the transfer of the lenses preferably takes place, in particular in horizontal or X direction, by pivoting the handover device or the lens between the cleaning stations.

Alternatively or additionally, the handling device can, however, also have an in particular common holder for a plurality of cleaning stations. In this embodiment of the cleaning device in accordance with the proposal, the transfer of the lenses or of the holder with the lens preferably takes place horizontally, in particular along the plurality of cleaning stations, particularly preferably in the X direction, particularly preferably by means of a carriage in particular travelable along a rail.

A further aspect of the present invention comprises a separate handling device having in particular its own or separate holder being respectively associated with each cleaning station of the cleaning device in accordance with the proposal. This permits a selective or individual and/or lens specific feed or positioning, and in particular cleaning, of the lens.

Individual ones of the above and following aspects and features of the present invention can be combined with one another as desired, but can also be implemented independently of one another.

Further aspects, features, advantages, and properties of the present invention result from the claims and the following description of preferred embodiments with reference to the drawings.

### BRIEF DESCRIPTION OF THE DRAWINGS

There are shown in a schematic representation, not true to scale:

FIG. 1 is a perspective representation of a cleaning device in accordance with the proposal in accordance with a first embodiment;

FIG. 2 is a front view of the cleaning device in accordance with FIG. 1;

FIG. 3A is a schematic side view of a brush with lenses that are travelable in a translatory manner transversely thereto;

FIG. 3B is a schematic plan view of a lens surface with residual structures remaining due to the cleaning by a brush in accordance with FIG. 3A;

FIG. 4A is a schematic side view of a brush with a lens rotatable transversely thereto;

FIG. 4B is a schematic plan view of a lens surface with residual structures remaining due to the cleaning by a brush in accordance with FIG. 4A in a first variant;

FIG. 4C is a schematic plan view of a lens surface with residual structures remaining due to the cleaning by a brush in accordance with FIG. 4A in a second variant;

FIG. 5 is a schematic section-like front view of a cleaning device in accordance with the proposal in accordance with a second embodiment; and

FIG. 6 is a plan view of the cleaning device in accordance with FIG. 5.

The same reference numerals are used for the same components and elements in the Figures even if a repeat description has been omitted.

### DETAILED DESCRIPTION OF THE INVENTION

The lens 2 is preferably an ophthalmic lens, particularly preferably a so-called eyeglass lens, that is a lens 2 for eyeglasses.

Only the lens 2 will mostly be spoken off in the following even though the cleaning device 10, 20 cleans or can clean a plurality of lenses 2 simultaneously.

The lens 2 preferably consists of plastic, but can optionally also comprise glass or the like.

The lens 2 preferably has a diameter of a plurality of centimeters, in particular of more than three centimeters.

The cleaning device 10, 20 is preferably configured such that a plurality of lenses 2 can be cleaned after one another and/or simultaneously.

The cleaning device 10, 20 preferably has a plurality of cleaning stations 11A/11B/11E, three in the example shown, with the cleaning stations 11A/11B/11E preferably being arranged next to one another or behind one another in a conveying direction X.

The cleaning device 10, 20 is optionally equipped with a transport system or at least one transport track (not shown) and/or is connected to a transport system having at least one transport track to feed the lens 2, for example after a prior treatment such as a shaping, in particular cutting, treatment (for example by milling or turning), a polishing, or a coating, to the cleaning device 10, 20 and/or to take the lens 2 away after the cleaning. The conveying on the transport system in particular takes place by means of a transport carrier (not shown) known per se for lenses, in particular ophthalmic lenses 2.

The transport system or the transport track(s) preferably extends/extend at least substantially in parallel with the conveying direction X. However, different constructive solution are also possible here.

The first cleaning station 11A, the second cleaning station 11B, and/or the third cleaning station 11E are preferably spatially separate from one another and/or each have spaces respectively separated from one another, in particular by walls.

The cleaning stations 11A/11B/11E preferably serve different cleaning processes and/or have different cleaning members. It is, however, also possible that the cleaning stations 11A/11B/11E serve the same cleaning process or have a similar design or configuration or are equipped with the same cleaning members.

In the embodiment shown, the cleaning stations 11A/11B are preferably configured for the cleaning of lenses 2 by a mechanical and/or chemical cleaning, in particular by a cleaning agent.

The first cleaning station 11A preferably has a brush 11C as the cleaning member. The cleaning device 10, 20 is preferably configured to clean a lens 2 mechanically and/or by means of the brush 11C in the first cleaning station 11A. The cleaning in the first cleaning station 11A in particular represents a pre-cleaning.

The brush 11C is preferably rotatable, in particular about an axis of rotation B, and/or is at least substantially cylindrical.

The brush 11C is preferably driven by a motor, in particular electrically, hydraulically, or pneumatically driven.

The speed of the brush 11C can be controlled and/or regulated. The speed of the brush can in particular be adapted as required in dependence on the desired cleaning or also in a lens specific manner.

The axis of rotation of the brush 11C preferably extends horizontally and/or transversely, in particular perpendicular, to the X direction, particularly preferably in the Y direction.

The first cleaning station 1A can optionally, have, in particular in addition to the brush 11C, one or more applicators 11D as the cleaning member to apply a cleaning agent to the lens 2 and/or the brush 11C. The applicator 11D is preferably configured as a nozzle.

The applicators 11D in particular serve the feed of the cleaning agent and/or are in particular configured to spray the cleaning agent onto the lens 2.

The applicators 11D are preferably oriented such that the cleaning agent is discharged or sprayed onto the lens 2, in particular directly. It is, however, also possible that the applicators 11D are additionally or alternatively oriented such that the cleaning agent is discharged on the brush 11C.

The cleaning agent is preferably a cleaning fluid and can comprise or consist of a cleaner or a cleaning chemical, a solvent, and/or water, in particular deionized or fully desalinated water.

The second cleaning station 11B preferably has the same properties as the first cleaning station 11A. The above explanations with respect to the first cleaning station 11A therefore preferably also apply to the second cleaning station 11B.

A pre-cleaning or a pre-wash preferably takes place in the first cleaning station 11A, in particular mechanically and/or by the brush 11C. A post-cleaning or post-washing preferably takes place in the second cleaning station 11B, in particular a chemical cleaning and/or a cleaning by means of the applicator 11D and/or by means of a cleaning agent.

The cleaning device 10, 20 preferably has a third cleaning station 11E. The third cleaning station 11E is preferably configured to dry the lens 2. The cleaning station 11E preferably has one or more fans 11F as the cleaning member for this purpose. The fans 11F are in particular configured to generate a, preferably warm, air flow or fan flow. A blowing off of liquid residues or of other contaminants and/or in particular a drying of the lens 2 can thus take place, for example.

The cleaning device 10, 20 optionally has, in particular in addition to the cleaning stations (11A, 11B, 11E), at least one coating station (not shown), with the coating device preferably being configured for the coating, in particular the hard coating or for the surface treatment or surface enhancement of the lens 2.

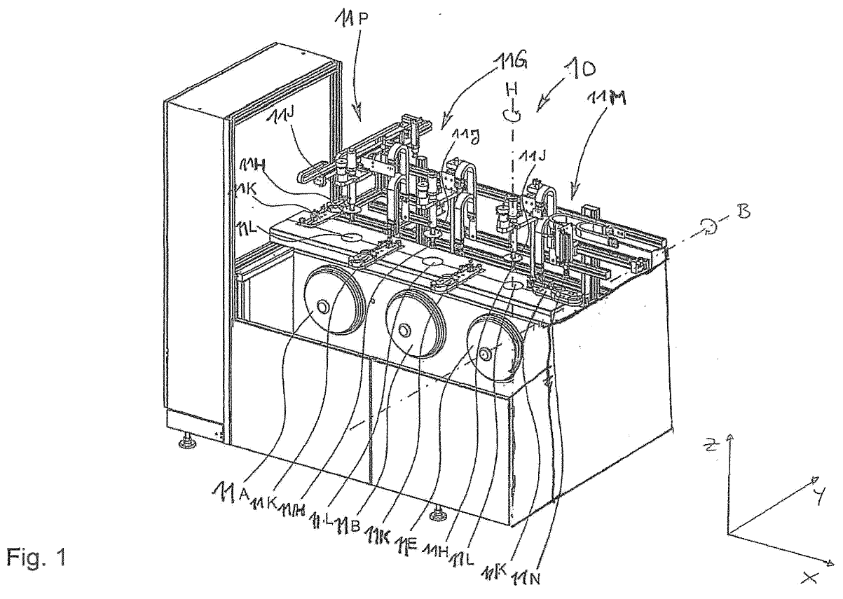

Some or all of the cleaning stations 11A/11B/11E are preferably arranged in a row or in an arrangement direction next to or behind one another, in the horizontal direction X here, as is indicated in FIGS. 1, 2, 5, and 6.

The cleaning device 10, 20 preferably has a handling device 11G, 21.

The cleaning device 10, 20 or the handling device 11G, 21 is preferably configured for the handling, in particular the direct and/or fully automated handling, of lenses 2 in the cleaning device 10, 20.

The cleaning device 10, 20 or handling device 11G, 21 is preferably configured such that the lens 2 can be or is fed transversely to the arrangement direction X. The cleaning device 10, 20 or handling device 11G, 21 is in particular configured such that the lens 2 can be or is fed to the cleaning stations 11A, 11B, 11E selectively or from above or in the vertical direction Z.

The handling device 11G, 21 is preferably configured for the handling and/or holding of one or more lenses 2 in the cleaning device 10, 20, in particular for the holding or positioning of the lens(es) 2 to be cleaned during a cleaning procedure in the respective cleaning station 11A/11B/11E.

The handling device 11G, 31 is furthermore preferably configured for the transfer of lenses 2 between the first cleaning station 11A, the second cleaning station 11B, and/or the third cleaning station 11E.

The handling device 11G, 21 preferably has a plurality of separate or constructionally separate components that form the handling device 11G, 21 together and/or are coordinated with one another or cooperate to handle the lenses 2 in the cleaning device 10, 20.

In accordance with a particularly preferred aspect of the present invention, the handling device 11G, 21 has at least one rotatable holder 11H, 21A. The holder 11H, 21A is preferably configured to hold a lens 2, in particular at one of its flat sides.

The holder 11H, 21A is preferably rotatable, in particular about an axis of rotation H.

The holder 11H, 21A is particularly preferably configured as a sucker that is in particular rotatable or has a sucker that is in particular rotatable to take up the lens 2 and to hold it, preferably in a rotating manner, for cleaning in the respective cleaning station or stations 11A, 11B, 11E.

The holder 11H, 21A is preferably driven by a motor, in particular electrically, hydraulically, or pneumatically driven

The speed of the holder 11H, 21A can be controlled or regulated. The speed of the holder 11H, 21A can in particular be adapted as required in dependence on the desired cleaning or also in a lens specific manner.

In accordance with a particularly preferred aspect of the present invention that can also be implemented independently, the holder 11H, 21A is rotatable, in particular about its longitudinal axis or axis of rotation H. The holder 11H, 21A is in particular configured such that the lens 2 is or can be held rotatingly or rotatably in the first, second, and/or third cleaning station 11A, 11B, and/or 11E during the cleaning and/or drying. The lens 2 is particularly preferably rotatable or held rotatably about its or the axis of rotation H.

The axis of rotation H of the holder 11H, 21A preferably extends vertically and/or transversely, in particular perpendicular, to the axis of rotation B of the brush 11C and/or to the X direction, particularly preferably in the Z direction.

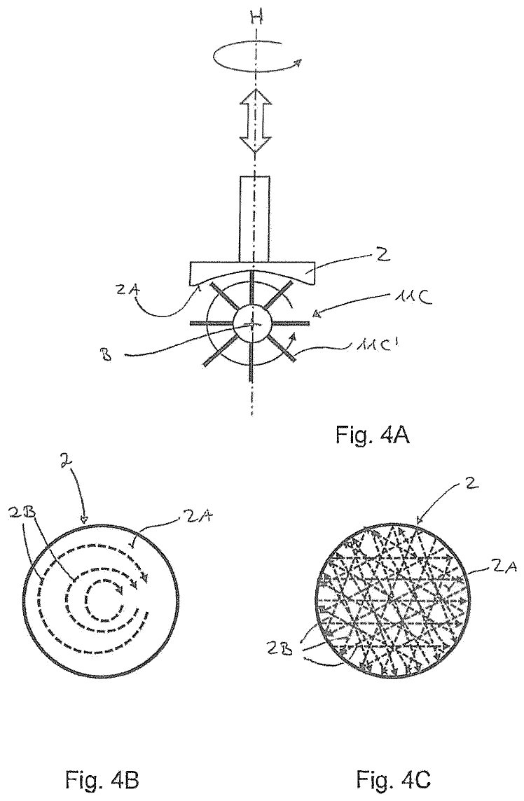

In accordance with a particularly preferred aspect of the present invention that can also be implemented independently, the axis of rotation H of the holder 11H, 21A or of the lens 2 extends transversely or at east substantially perpendicular to the axis of rotation B of the brush 11C, as indicated in FIG. 4A.

On the cleaning of the lens 2 or of the lens surface 2A to be cleaned, structural formations or residual structures 2B that can in particular be irritating for the human eye can arise due to or on the contact of the brush 11C or bristles 11C′ with the lens surface 2A, in particular in the case of soft materials of the lens 2.

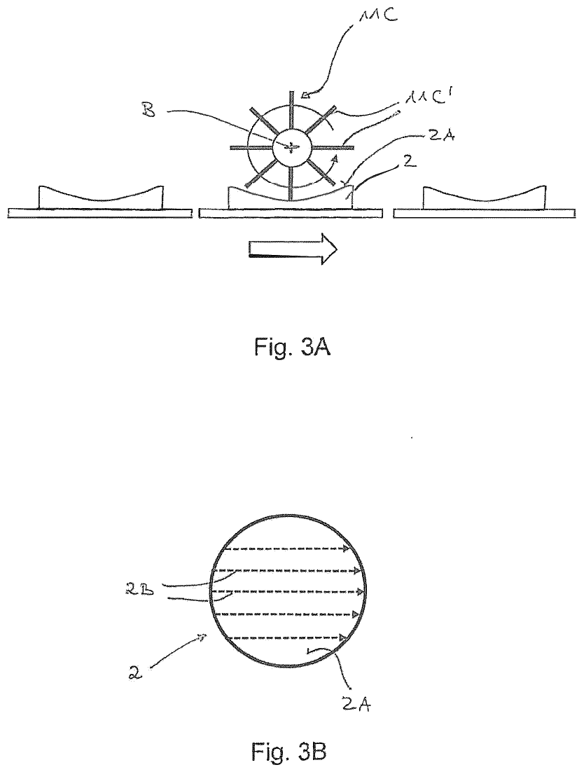

In DE 10 2017 007 752 A1, the lens 2 is moved transversely or linearly or translatorily to the axis of rotation B of the rotatable brush 11C. On the translatory movement during the cleaning via the rotating brush 11C (FIG. 3A), residual structures 2B as indicated in FIG. 3B, in particular in the form of a linear pattern, can in particular be produced here by the contact of the bristles 11C′ with the lens surface 2A.

Such regular patterns due to irregularly or non-uniformly distributed residual structures 2B, in particular on the lens surface, can be irritating for the human eye and are to be avoided.

On a rotational movement of the lens 2 or of the holder 11H, 21A with the lens 2 transversely to the axis of rotation B of the rotatable or rotating brush 11C, residual structures 2B, for example in the form of circular structures or partially circular structures (FIG. 4B) and/or in the form of irregularly distributed or in particular overlapping individual or linear patterns (FIG. 4C) can arise due to the contact of the bristles 11C′ with the lens surface 2A.

The rotational movement of the holder 11H or of the lens 2 of the cleaning device 10, 20 in accordance with the proposal in particular makes a longer application time of the bristles 11C′ or of the contact force possible.

The rotational movement of the holder 11H, 21A or of the lens 2 furthermore permits a more powerful or greater distribution of residual structures 2B with respect to the total lens surface 2A. A superposition or stochastic or irregular distribution at residual structures 2B is in particular made possible. As in particular indicated in FIG. 4C, no individual patterns or patterns recognizable to the human eye thus preferably remain.

This in particular permits no or hardly any irritating residual structures 2B in the form of individual patterns to be recognizable, in particular after a coating of the lens 2, due to the particularly homogeneous distribution or superposition at residual structures 2B.

The in particular rotatable holder 11H, 21A is in particular travelable vertically, in particular in the Z direction. The holder 11H, 21A is preferably configured to introduce the lens 2 into the cleaning station 11A, 11B, or 11E, in particular vertically from above, to hold it in an in particular rotating manner during the cleaning, and to move the lens 2 out of the cleaning station 11A, 11B, or 11E again after the cleaning.

A further aspect of the present invention comprises the lens 2 or the holder 11H, 21A with the lens 2 being feedable or positionable or being able to be supplied, in particular in a lens specific manner, to one or more cleaning members in the respective cleaning station 11A, 11B, 1E, preferably to the brush 11C. A desired and/or adapted lens specific feed can particularly preferably take place, in particular in dependence on the geometry of the lens 2 or of the lens surface 2A.

The lens 2 can in particular preferably be positioned with respect to the brush 11C, preferably vertically, particularly preferably in the Z direction. The distance of the lens 2 or of the lens surface 2A from the respective cleaning member, in particular from the brush 11C can in particular be set. This individual or lens specific supply of the lens 2 enables a particularly uniform force effect, or a force effect adapted to the lens specific cleaning demands, of the cleaning member, in particular of the bristles 11C′ of the brush 11C, on the lens 2 or lens surface 2A to be cleaned.

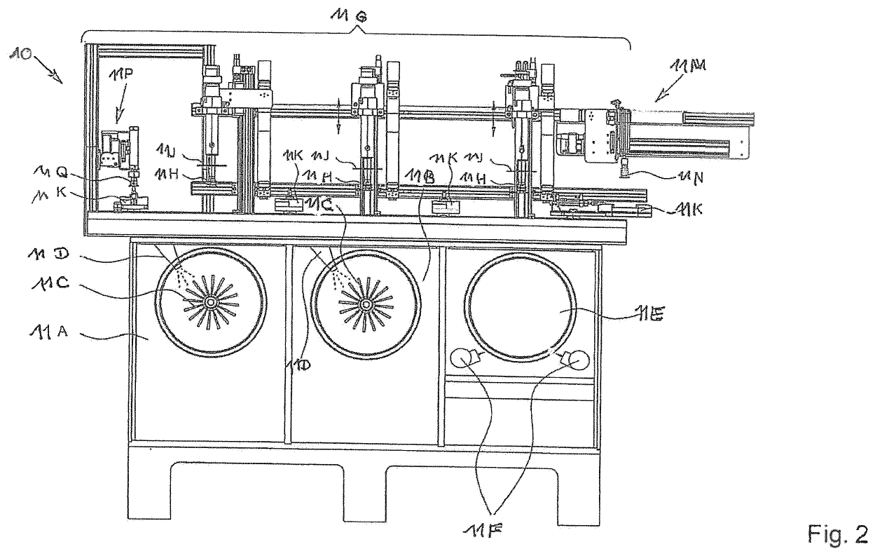

A first embodiment of a cleaning device 10 in accordance with the proposal is shown in FIG. 1 and FIG. 2.

The cleaning station 10 preferably has a handling device 11G for feeding the lens 2 to the cleaning stations 11A, 11B, or 11E.

In the example shown, the handling device 11G preferably has a plurality of holders 11H, particularly preferably each in the form of a sucker that is in particular rotatable to take up the lens 2 and to hold it, preferably in a rotating manner, for cleaning in the respective cleaning station or stations 11A, 11B, 11E.

In accordance with the embodiment of the cleaning device 10 in accordance with the proposal shown in FIG. 1 and FIG. 2, a respective separate holder 11H is associated with the first cleaning station 11A, the second cleaning station 11B, and/or the third cleaning station 11E. The holders 11H are preferably of the same design.

The first cleaning station 11A, the second cleaning station 11B, and/or the third cleaning station 11E of the cleaning device 10 in accordance with the proposal preferably (respectively) has/have an opening 11L through which a lens 2 can be or is fed to the cleaning station 11A/11B/11E.

In the example shown, the holder 11H preferably has a cover 11J for covering or closing the opening 11L of the cleaning station 11A, 11B, or 11E through which the lens 2 is introduced with the holder 11H into the cleaning station 11A, 11B, or 11E.

The cleaning device 10 or handling device 11G preferably has at least one handover device 11K.

The handover device 11K is preferably configured for the transfer of a lens 2 between two holders 11H, in particular between the holder 11H associated with a first cleaning station 11A/11B/11E and the holder 11H associated with the cleaning station 11A/11B/11E adjacent to the first cleaning station 11A/11B/11E.

The handover device 11K is preferably respectively arranged between the cleaning stations 11A, 11B, or 11E and/or is configured to take over a lens 2 from the holder 11H associated with a first cleaning station 11A/11B/11E and/or to hand it over to the holder 11H associated with a second cleaning station 11A/11B/11E or with the cleaning station 11A/11B/11E adjacent to the first cleaning station.

The handover device 11K is preferably configured to center the lens 2. Handling errors can in particular hereby be avoided or reduced that arise, for example, in that the lens 2 held at the holder 11H is slightly displaced on the cleaning in one of the cleaning stations 11A, 11B.

The handover device 11K is preferably pivotable, in particular about a vertical axis. The handover device 11K is in particular pivotable between a first position in which the handover device 11K is preferably arranged above the opening 11L of a first cleaning station 11A/11B/11E and/or below the holder 11H associated with a first cleaning station 11A/11B/11E and a second position in which the handover device 11K is preferably arranged above the opening 11L of a second cleaning station or of the first cleaning station 11A/11B/11E adjacent to the first cleaning station and/or below the holder associated with a second cleaning station or the cleaning station 11A/11B/11E adjacent to the first cleaning station. The handover device 11K is preferably pivotable by 180° between these positions, in particular about a vertical axis.

The transfer of a lens 2 from the first cleaning station 11A to the second cleaning station 11B preferably takes place in that the holder 11H associated with the first cleaning station 11A hands over the lens 2 to the handover device 11K, in particular places it in the handover device 11K, the handover device 11K is pivoted from the first position into the second and possibly centers the lens 2 in so doing, and finally, in the second position, the holder 11H associated with the second cleaning station 11B takes over the lens 2 from the handover device 11K.

In addition to the handover device 11K described above, the cleaning station 10 or the handling device 11G preferably has a second handover device 11K to transfer a lens 2 between the holder 11H associated with the second cleaning station 11B and the holder 11H associated with the third cleaning station 11E.

The cleaning device 10 or the first handling device 11G preferably has a transfer device 11M to transfer the lens 2 to a further processing station, particularly preferably to a coating station, in the example shown.

The transfer device 11M preferably has a holder 11N for a lens 2. The holder 11N preferably has a sucker or is formed thereby.

The cleaning device 10 or the handling device 11G preferably has a further or third handover device 11K to transfer a lens 2 from the holder 11H associated with the cleaning station 11E to the transfer device 11M.

The third handover device 11K is preferably pivotable, in particular between a first position in which the third handover device 11K is preferably arranged above the opening 11L of the third cleaning station 11E and/or below the holder 11H associated with the third cleaning station 11E and a second position in which the third handover device 11K is preferably arranged below the transfer device 11M or the holder 11N.

The described handover devices 11K are preferably of the same design.

The transfer device 11M or the holder 11N is preferably arranged and/or movable horizontally and/or between the cleaning device 10 or the third handover device 11K and the in particular optional coating station.

This in particular takes place in that, when the lens 2 has been moved out of the cleaning station 11E with the holder 11H, the third handover device 11K is first arranged above the opening 11L or below the holder 11H associated with the drying device 11E, the lens 2 is first handed over to the third handover device 11K, and the third handover device 11K is then pivoted into a position in which the lens 2 is taken over with the holder 11N. The holder 11N then removes the lens 2 from the third handover device 11K, travels into a position in which the lens 2 can be transferred to a desired point and optionally transfers the lens 2 to a further processing station, preferably to a coating station.

The cleaning device 10 or the first handling device 11G preferably has a transfer device 11P to transfer the lens 2 by the transport system (not shown) to the cleaning device 10.

The transfer device 11P preferably has a holder 11Q for a lens 2. The holder 11Q preferably has a sucker or gripper or is formed thereby.

The holder 11Q is preferably movable or travelable horizontally and/or along the transfer device 11P. The transfer device 11P preferably extends at least substantially transversely, in particular perpendicular, to the transport track T1, T2, T3 (not shown), and/or horizontally.

The cleaning device 10 or the first handling device 11G preferably has a fourth handover device to transfer lenses 2 between the transfer device 11P and the holder 11H associated with the first cleaning station 11A.

The fourth handover device 11K is preferably of the same design as the first, second, and/or third handover devices 11K.

The fourth handover device 11K is preferably pivotable, in particular between a first position in which the fourth transfer device 11K is preferably arranged below the holder 11Q and a second position in which the fourth handover device is preferably arranged above the opening 11L of the first cleaning station 11A and/or below the holder 11H associated with the first cleaning station 11A.

The transfer device 11P is preferably configured to remove a lens 2 from the transport system or from a transport carrier and subsequently to transfer the lens 2 to the fourth handover device 11K and to place it in the handover device 11K. The handover device 11K is preferably configured to center the lens 2 and to pivot it in a position in which the holder 11H, that is associated with the first cleaning station 11A, can remove the lens 2 from the handover device 11K.

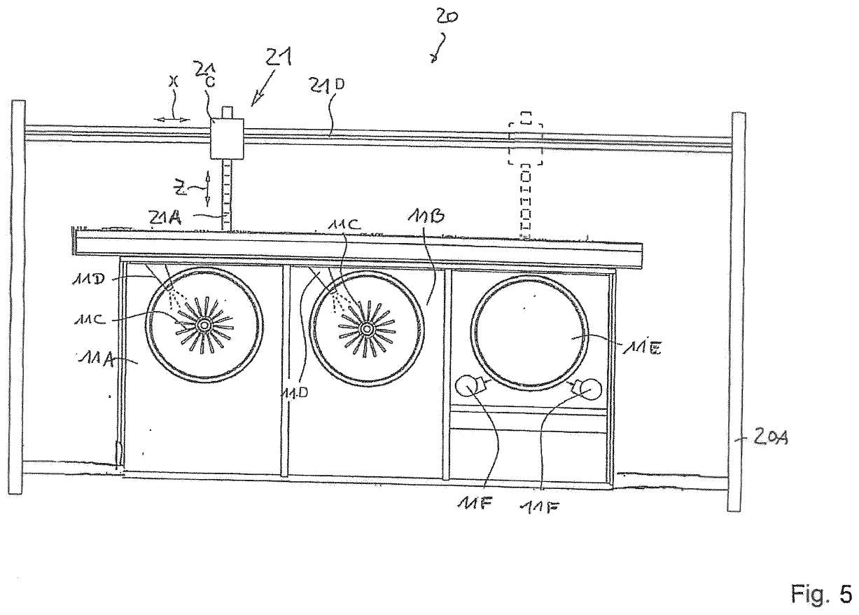

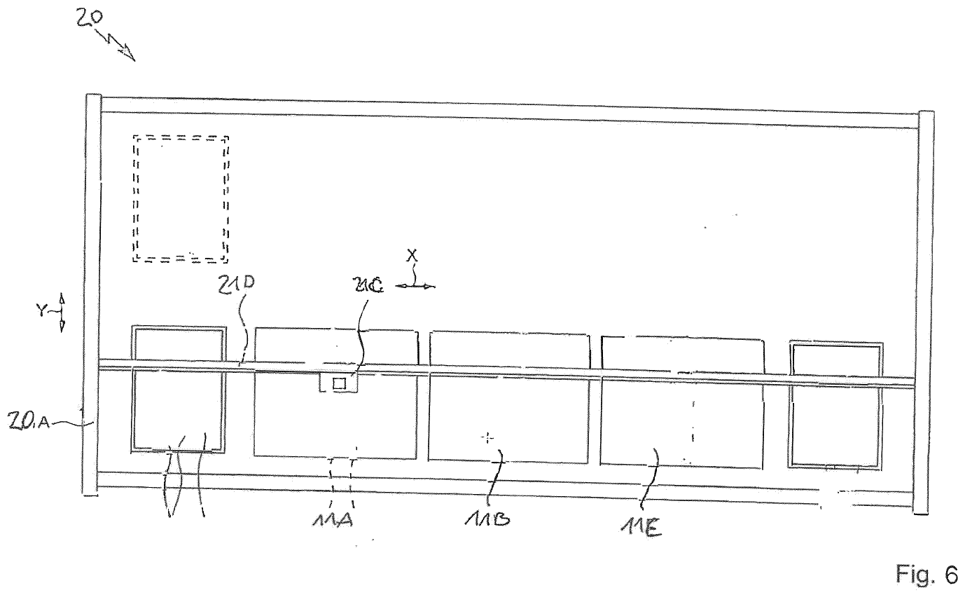

FIGS. 5 and 6 show a further embodiment of a cleaning device 20 in accordance with the proposal for cleaning a lens 2.

The cleaning device 20 preferably has a handling device 21 for feeding the lens 2 to the cleaning stations 11A, 11B, or 11E.

The handling device 21 is in particular configured (only) to equip a respective single one of the cleaning stations 11A, 11B, 11E with the respective lens 2 to be cleaned.

The cleaning device 20 or handling device 21 is in particular configured to feed the lens 2 selectively to one of the cleaning stations 11A, 11B, 11E. The cleaning stations 11A, 11B, 11E can therefore in particular be equipped with a lens 2 independently of one another and/or can be operated independently of one another.

Some or all of the cleaning stations 11A, 11B, 11E are preferably arranged in a row or in an arrangement direction next to or behind one another, in the horizontal direction X here, as is indicated in FIGS. 5 and 6. The cleaning device 20 or handling device 21 is preferably configured such that the lens 2 can be or is fed transversely to the arrangement direction X. The cleaning device 20 or handling device 21 is in particular configured such that the lens 2 can be or is fed to the cleaning stations 11A, 11B, 11E selectively or from above or in the vertical direction Z. The cleaning device 20 or the handling device 21 is furthermore preferably configured such that the lens 2 is movable in the arrangement direction X to be able to individually travel to and equip the cleaning stations 11A, 11B, 11E after one another or in any desired order.

In accordance with a further aspect of the present invention that can also be implemented independently, the cleaning device 20 or handling device 21 is preferably configured such that the lens 2 is also movable transversely or perpendicular to the feed direction Z and is also in particular movable transversely or perpendicular to the arrangement direction or the direction of movement X in a transverse direction Y, as is schematically indicated in the plan view in accordance with FIG. 6.

The X direction and the Y direction preferably extend horizontally and/or perpendicular to the feed direction Z.

The handling device 21 preferably has a drive and/or a carriage 21C for the holder 21A to enable the desired movement, in particular in the X direction.

The handling device 21 furthermore preferably has a rail 21D that extends in the X direction or in the arrangement direction of the cleaning stations 11A, 11B, 11E and/or holds or guides the holder 21A or the carriage 21C, in particular displaceably by a motor.

In the example shown, the holder 21A, the carriage 21C, and/or the rail 21D is/are preferably additionally also movable or displaceable in the transverse direction Y, in particular by a corresponding guide and/or support of the rail 21D at a rack 20A of the cleaning device 20. Other constructive solutions are also possible, however.

The corresponding movements or displacements or adjustments in particular take place by a motor, particularly preferably by an electric, hydraulic, and/or pneumatic drive, and/or controlled, particularly preferably regulated, and/or by servo drives.

A location regulated positioning particularly preferably takes place, in particular of the lens 2 relative to or within one or more or all of the cleaning stations 11A, 11B, 11E, by means of the handling device 21. The location regulation or positioning in particular takes place in a lens specific manner and/or specifically for the respective cleaning station 11A, 11B, 11E and can in particular take place selectively in the Z, X, and/or Y directions. The handling device is PLC or CNC controlled, for example.

### REFERENCE NUMERAL LIST

2 lens
2A lens surface
3B residual structure
10 cleaning device
11A (first) cleaning station
11B (second) cleaning station
11C brush
11D applicator
11E (third) cleaning station
11F fan
11G handling device
11H holder
11J cover
11K handover device
11L opening
11M transfer device
11N holder
11P transfer device
11Q holder of 11P
20 cleaning device
20A rack
21 handling device
21A holder
21C carriage
21D holder
B axis of rotation (brush)
H axis of rotation (holder/lens)

1-8. (canceled)

9. A cleaning device for cleaning at least one lens, the cleaning device comprising:
at least one cleaning station; and
at least one handling device for feeding the lens to the at least one cleaning station;
wherein the handling device has at least one rotatable holder for rotatable holding of the lens.

10. The cleaning device in accordance with claim 9, wherein the at least one handling device is operable to feed the lens from above or in a vertical direction.

11. The cleaning device in accordance with claim 9, wherein the at least one holder is adjustable or movable in a vertical direction for lens specific location regulation or positioning of the lens.

12. The cleaning device in accordance with claim 9, wherein the at least one cleaning station comprises a plurality of cleaning stations arranged next to one another or behind each other in a direction and the at least one handling device is configured to transfer the lens.

13. The cleaning device in accordance with claim 12, wherein the direction is a horizontal direction and the at least one handling device is configured to transfer the lens in the horizontal direction.

14. The cleaning device in accordance with claim 12, further comprising at least one handover device for the transfer of the lens between the cleaning stations.

15. The cleaning device in accordance with claim 13, wherein the at least one handling device has a carriage that is adjustable or movable in the horizontal direction to transfer the lens in the horizontal direction.

16. The cleaning device in accordance with claim 15, wherein the carriage is adjustable or movable in the horizontal direction along a rail.

17. The cleaning device in accordance with claim 15, wherein the carriage transfer the lens in the horizontal direction selectively to one of the cleaning stations.

18. The cleaning device in accordance with claim 9, wherein the at least one cleaning station has a rotatable brush as a cleaning member.

19. The cleaning device in accordance with claim 18, wherein the at least one cleaning station has exactly one rotatable brush as a cleaning member.

20. The cleaning device in accordance with claim 18, wherein an axis of rotation of the brush is arranged horizontally and/or at least substantially perpendicular or transversely to an axis of rotation of the corresponding holder.

21. A method of cleaning at least one lens, comprising;
providing a cleaning device for cleaning the at least one lens, the cleaning device comprising;
at least one cleaning station; and
at least one handling device for feeding the lens to the at least one cleaning station;
wherein the handling device has at least one rotatable holder for rotatable holding of the lens
carrying out a cleaning procedure in the at least one cleaning station;
wherein;
the at least one lens is held in a rotating manner in the at least one cleaning station at least during the cleaning procedure; and/or
the at least one lens rotates about an axis of rotation and a brush rotates about an axis of rotation during the cleaning procedure, said axis of rotation being arranged substantially horizontally and/or at least substantially perpendicular or transversely to the axis of rotation; and/or
the at least one lens and the brush rotate at least substantially perpendicular or transversely to one another during the cleaning procedure.
